(19) United States
(12) Patent Application Publication
(10) Pub. No.: US 2022/0185436 A1
(43) Pub. Date: Jun. 16, 2022

(54) AUTONOMOUS NAVIGATION TYPE MARINE BUOY AND MARINE INFORMATION SYSTEM USING THE SAME

(71) Applicant: KANESHIKA CONSULTING, Hyogo (JP)

(72) Inventor: Isao Kaneshika, Hyogo (JP)

(21) Appl. No.: 16/757,731

(22) PCT Filed: Aug. 19, 2019
(86) PCT No.: PCT/JP2019/032310

§ 371 Date: Apr. 20, 2020

(51) Int. Cl. B63C 9/06; B63B 79/15; B63B 79/40; G05D 1/00; G05D 1/02; B63H 25/44; G01C 21/20

(52) U.S. Cl. CPC B63C 9/06; B63B 79/15; B63B 79/40; G01C 21/203; G05D 1/0206; G05D 1/0022; B63H 25/44; G05D 1/0088

(57) ABSTRACT

An autonomous navigation type marine buoy includes: a buoy body consisting of a floating body; an internal sensor; a detection unit that receives a GPS signal and information of the internal sensor; an on-water exploration unit that explores a state on a sea; an underwater exploration unit that explores a state under the sea; a determination unit that creates a navigation plan for the buoy body; a propulsion unit that propels the buoy body; a navigation control unit that performs drive control of the propulsion unit so that the buoy body navigates according to the navigation plan; a power generation unit; a power storage unit; a communication unit that communicates with an outside; an emergency signal unit that receives a distress signal and specifies a transmission position of the distress signal; and an evacuation room that accommodates a victim, in which the autonomous navigation type marine buoy has an autonomous navigation mode of performing autonomous navigation to a set position on the sea, a home position mode of autonomously holding a home position at the set position on the sea, and a rescue mode of performing autonomous navigation to the transmission position of the distress signal on the sea when the distress signal is received.

### TECHNICAL FIELD

The present invention relates to an autonomous navigation type marine buoy that automatically goes to a distress place to rescue in an emergency while autonomously monitoring a certain range on the sea set in advance.

### BACKGROUND ART

Observation in the ocean, which accounts for about 70% of the earth's surface area, requires a lot of observation data due to a wide observation range and complexity of an observation target. In addition, it is important to grasp weather and marine state information in real time in situations such as ship navigation, fishery, prediction of a drifting object and an outflow from a ship such as oil, and lifesaving in the event of a marine accident. Therefore, an autonomous marine observation device has been introduced in order to expand an ocean survey range and collect more information.

PTL 1 discloses a wave-powered autonomous navigation type water vehicle. The vehicle includes a float that floats on a sea surface, a swimmer that sinks in the sea, and a tether that connects the float and the swimmer. The swimmer has a plurality of fins that interact with water to generate propulsion. The vehicle also includes various sensors that detect changes in an observable situation and communication devices that report the situation.

In addition, there is a device to rescue a victim in the event of a distress as a necessary thing at sea. For example, PTL 2 discloses a self-propelled lifesaving vehicle. This lifesaving vehicle includes a disk-shaped hollow body and a pair of jet motors provided on side portions facing in a radial direction of the body and generating a jet flow that propels the vehicle. By installing a self-propelling function, this lifesaving vehicle can quickly and efficiently transport a person who needs to be rescued from a disaster area to a safe place.

Further, PTL 3 proposes a rescue system that guides a rescue boat to a destination where a victim is located. This system includes a processing device that automatically selects a rescue boat closest to a victim from among registered rescue boats that sail on the sea, automatically transmits a direction and a distance to the victim to the rescue boat as information, and issues a start command to the rescue boat.

### CITATION LIST

### Patent Literature

PTL 1: JP 2012-046178 A
PTL 2: JP 2013-531578 A
PTL 3: JP 9-304506 A

### SUMMARY OF INVENTION

### Technical Problem

In recent years, there have been frequent problems of territorial waters violation and poaching in an exclusive economic zone by foreign ships. Under such circumstances, there is a need for a monitoring and rescue mechanism that can not only observe weather and a marine state, but also autonomously monitor a wide sea area thoroughly and go to victim's rescue in an emergency.

However, the water vehicle in PTL 1 has neither a function of monitoring states on the sea and in the sea nor a function of rescuing a victim, and the lifesaving vehicle in PTL 2 does not have a function of observing weather or the like at normal times. Further, in the rescue system in PTL 3, although the rescue boat is remotely controlled by the central processing device, the rescue boat does not autonomously go to rescue.

The present invention has been made in view of such circumstances. In order to solve the above problems, an object of the present invention is to provide an autonomous navigation type marine buoy that functions as a monitoring buoy and autonomously goes to the rescue of a victim when a distress signal is received, and to provide a victim rescue system using the buoy.

### Solution to Problem

In order to achieve the above object, an autonomous navigation type marine buoy according to one aspect of the present invention includes on-water and underwater exploration units and has a function of autonomously navigating or holding a home position on the sea.

In other words, an autonomous navigation type marine buoy according to one aspect of the present invention includes: a buoy body consisting of a floating body; at least one internal sensor provided in the buoy body; a detection unit that receives a GPS signal and information of the internal sensor; an on-water exploration unit that explores a state on a sea; an underwater exploration unit that explores a state under the sea; a determination unit that creates a navigation plan for the buoy body along a target route set based on position information of the buoy body detected by the detection unit and chart information; a propulsion unit that propels the buoy body; a navigation control unit that performs drive control of the propulsion unit so that the buoy body navigates according to the navigation plan generated by the determination unit; a power generation unit that generates power using natural energy; a power storage unit that stores electricity generated by the power generation unit and supplies electricity to a necessary location in the buoy body; a communication unit that communicates with an outside; an emergency signal unit that receives a distress signal and specifies a transmission position of the distress signal; and an evacuation room for evacuating a victim from the outside, in which the autonomous navigation type marine buoy has an autonomous navigation mode of performing autonomous navigation to a set position on the sea according to the navigation plan, a home position mode of autonomously holding a home position at the set position on the sea, and a rescue mode of performing autonomous navigation to the transmission position of the distress signal on the sea when the distress signal is received.

In addition to the functions of autonomous navigation to a destination and holding of the home position on the sea based on the GPS signal, the information of the internal sensor, and the chart information, the autonomous navigation type marine buoy configured as described above has a function of autonomously rescuing a victim in a marine accident. Generally, when a ship is in distress, a distress signal is transmitted automatically or manually. This signal is transmitted in a predetermined format, and includes a call sign of a distress ship, distress position information obtained from a GPS receiver, clock information, and the like. When the autonomous navigation type marine buoy receives these pieces of information, it creates a navigation route from its own position to a distress position, and autonomously goes to the distress position to rescue a victim without waiting for an external command.

Also, the autonomous navigation type marine buoy configured as described above is equipped with the evacuation room where a victim can stay temporarily. With this configuration, the victim can be evacuated to a safe place.

In addition, a marine information system according to one aspect of the present invention includes a plurality of the autonomous navigation type marine buoys arranged in a lattice form in a certain water area.

According to the marine information system configured as described above, in an area where the autonomous navigation type marine buoys are located, it is possible to monitor states on the sea and under the sea, grasp weather and marine state information, construct a maritime rescue network, and construct a wireless communication network. For example, when the autonomous navigation type marine buoys are arranged at equal intervals of 50 km in Japan's exclusive economic zone, about 2000 units are arranged. In this way, it will be possible to monitor states on the sea and under the sea, grasp weather and marine state information, construct a maritime rescue network, and construct a wireless communication network for all areas in Japan's exclusive economic zone.

### Advantageous Effects of Invention

According to the present invention, it is possible to provide the autonomous navigation type marine buoy that functions as a monitoring buoy and autonomously goes to the rescue of a victim when a distress signal is received and to provide the victim rescue system using the buoy.

### BRIEF DESCRIPTION OF DRAWINGS

FIG. 1 is a perspective view of an autonomous navigation type marine buoy according to an embodiment of the present invention.

FIG. 2A is a view for describing a steering principle of the autonomous navigation type marine buoy.

FIG. 2B is a view for describing the steering principle of the autonomous navigation type marine buoy.

FIG. 2C is a view for describing the steering principle of the autonomous navigation type marine buoy.

FIG. 2D is a view for describing the steering principle of the autonomous navigation type marine buoy.

FIG. 3A is a view for describing a principle of holding a home position of the autonomous navigation type marine buoy.

FIG. 3B is a view for describing the principle of holding the home position of the autonomous navigation type marine buoy.

FIG. 3C is a view for describing the principle of holding the home position of the autonomous navigation type marine buoy.

FIG. 3D is a view for describing the principle of holding the home position of the autonomous navigation type marine buoy.

FIG. 3E is a view for describing the principle of holding the home position of the autonomous navigation type marine buoy.

FIG. 4 is a block diagram showing an overall configuration of a control system of the autonomous navigation type marine buoy.

FIG. 5 is a flowchart showing a control flow of the autonomous navigation type marine buoy.

FIG. 6 is a view showing a state in which a plurality of autonomous navigation type marine buoys are arranged in Japan's exclusive economic zone.

FIG. 7 is a view for describing rescue operation of the autonomous navigation type marine buoys.

### DESCRIPTION OF EMBODIMENTS

An embodiment of the present invention will be specifically described below with reference to the accompanying drawings.

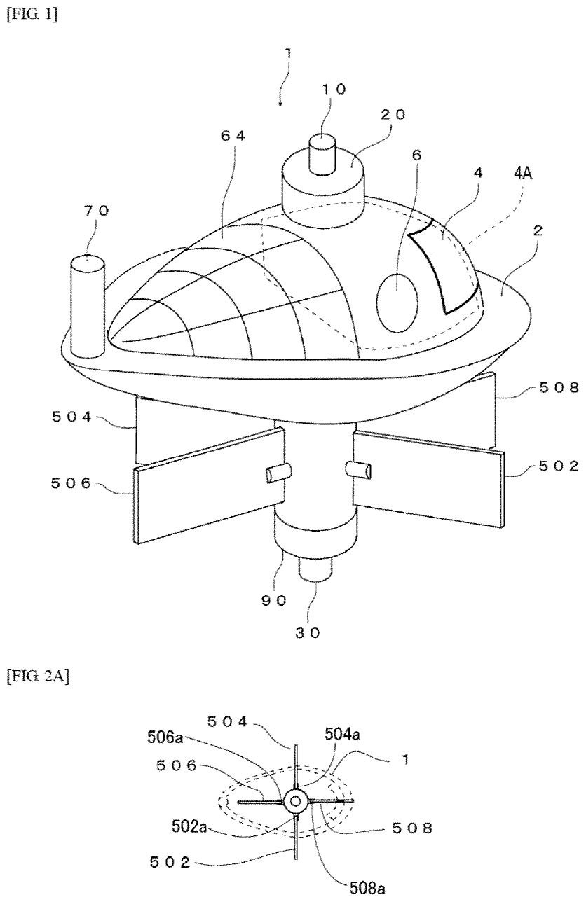

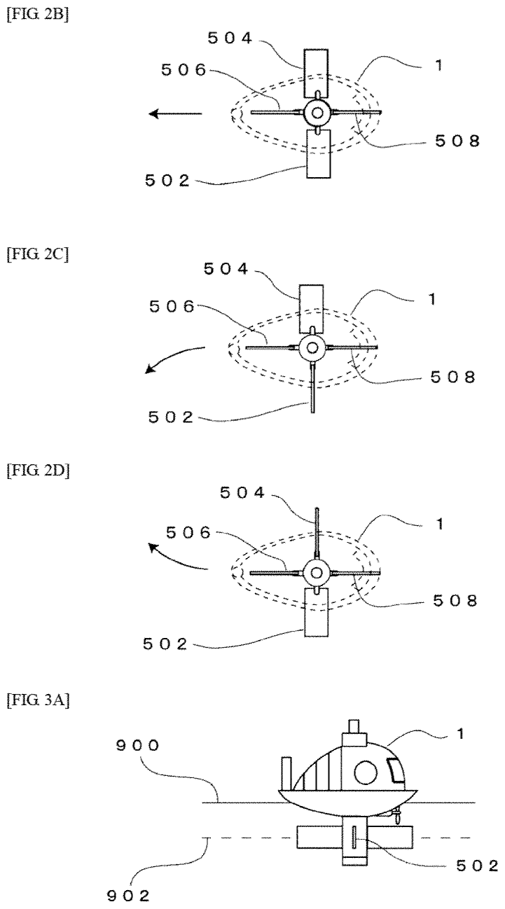

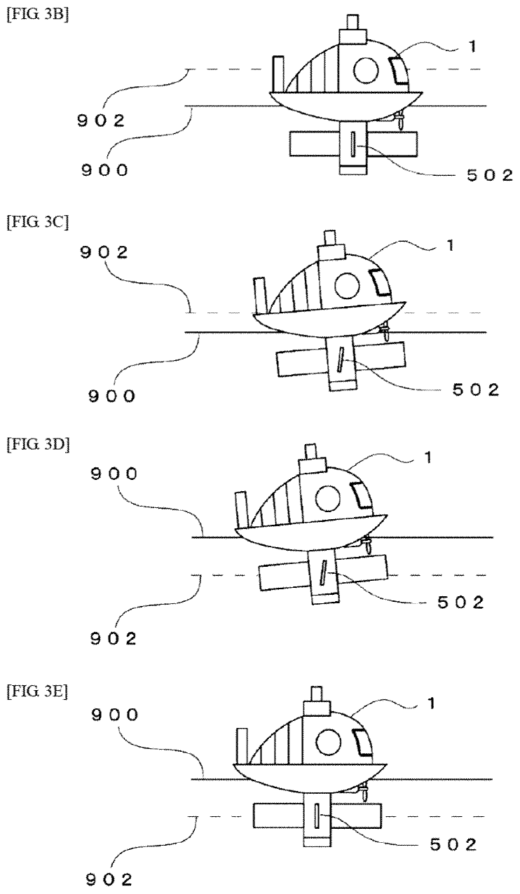

FIGS. 1 to 3 show an autonomous navigation type marine buoy 1 according to the embodiment of the present invention. FIG. 1 is a perspective view of the autonomous navigation type marine buoy 1 according to the embodiment of the present invention, FIGS. 2A to 2D are views for describing a steering principle of the autonomous navigation type marine buoy 1, and FIGS. 3A to 3E are views for describing a principle of holding a home position of the autonomous navigation type marine buoy 1.

Referring to FIG. 1, the autonomous navigation type marine buoy 1 according to the present embodiment includes a buoy body 2 consisting of a floating body. The buoy body 2 has a form in which half-broken eggs of different sizes are joined. An upper part of a half-broken egg shape and a lower part of a half-broken egg shape larger than the upper part are joined at a joint. Buoyancy of the buoy body 2 is designed such that the joint is held at a position above a sea surface. A victim can get on the joint and enter an evacuation room 4A from an evacuation room entrance 4 provided at the upper rear of the buoy body 2. A transparent window 6 is provided in the evacuation room 4A, and the victim who has evacuated to the evacuation room 4A can view the sea through the transparent window 6.

The autonomous navigation type marine buoy 1 includes a communication unit 70 provided at an external head of the buoy body 2 that appears on the sea, a solar power generation panel 64 provided at an upper part of the buoy body 2, and an on-water exploration unit 20 and a detection unit 10 provided on a ceiling of the buoy body 2. Further, the autonomous navigation type marine buoy 1 includes the communication unit 70, the solar power generation panel 64, the detection unit 10, and the on-water exploration unit 20 provided at the upper part of the buoy body 2. The communication unit 70 is equipped with a required radio wave transceiver.

A cylindrical movable wing support unit 510 is provided at a lower part of the buoy body 2.

Around the movable wing support unit 510, a left movable wing 502, a right movable wing 504, a front movable wing 506, and a rear movable wing 508 are provided. These movable wings 502, 504, 506, and 508 can rotate around rotating shafts thereof. At a lower end of the movable wing support unit 510, a marine state observation unit 90 and an underwater exploration unit 30 are provided. The marine state observation unit 90 is equipped with measurement sensors for a wave height, water temperature, a flow direction, and flow speed. Further, the underwater exploration unit 30 is equipped with an underwater camera 32 capable of photographing 360 degrees and sonar 34.

Subsequently, a steering principle of the autonomous navigation type marine buoy 1 will be described with reference to FIGS. 2A to 2D. FIGS. 2A to 2D are views of the autonomous navigation type marine buoy 1 as seen from above, showing states when it is stationary (FIG. 2A), when it travels straight (FIG. 2B), when it turns left (FIG. 2C), and when it turns right (FIG. 2D).

When the autonomous navigation type marine buoy 1 is stationary (FIG. 2A), the left movable wing 502, the right movable wing 504, the front movable wing 506, and the rear movable wing 508 are oriented in a vertical direction. Note that a principle of holding a home position will be described later.

When the autonomous navigation type marine buoy 1 travels straight (FIG. 2B), the right movable wing 504 and the left movable wing 502 are oriented in a horizontal direction. Thus, the autonomous navigation type marine buoy 1 can navigate to a destination with resistance of seawater minimized.

When the autonomous navigation type marine buoy 1 turns left (FIG. 2C), the right movable wing 504 is orientated in the horizontal direction, and the left movable wing 502 is orientated in the vertical direction. Then, the resistance of the seawater on a left side of the autonomous navigation type marine buoy 1 increases, and the autonomous navigation type marine buoy 1 turns left.

A direction of the right turn (FIG. 2D) is different from that of the left turn (FIG. 2C), but the principle is the same.

Next, with reference to FIGS. 3A to 3E, a principle of holding a home position of the autonomous navigation type marine buoy 1 will be described. When the autonomous navigation type marine buoy 1 arrives at a destination by autonomous navigation, the autonomous navigation type marine buoy 1 enters a home position holding mode, and continues monitoring or observation while autonomously holding its own position at the home position. FIGS. 3A to 3E are views of the autonomous navigation type marine buoy 1 as seen from the side, showing states in which it falls from the top of a wave (FIG. 3A) to the bottom of the wave (FIG. 3B) and again back to the top of the wave (FIG. 3E) in order. These figures show a principle of autonomously correcting a position when a current position of the autonomous navigation type marine buoy 1 is slightly shifted backward from the home position.

When the autonomous navigation type marine buoy 1 is on the surging wave (FIG. 3A), a sea surface 900 when there is a wave is higher than a sea surface 902 when there is no wave. At this time, the left movable wing 502 and the right movable wing 504 (not shown) are oriented in the vertical direction. Then, when the sea surface 900 when there is a wave descends as it is (FIG. 3B), it descends most at the same position on a horizontal plane. Compared with a state in FIG. 3A, it descends twice as much as the wave height difference between the sea surface 900 when there is a wave and the sea surface 902 when there is no wave. When the next wave comes, the autonomous navigation type marine buoy 1 starts to rise again. At this time, the left movable wing 502 and the right movable wing 504 are inclined backward from the vertical direction. Then, the autonomous navigation type marine buoy 1 rises forward due to resistance of a water current at the time of rising, and slightly travels forward from the position before an effect finally starts (FIG. 3A). Thereafter, this operation is repeated to hold the home position.

This home position holding operation is realized by driving a steering motor 56 using electric power generated by the solar power generation panel 64 as an energy source, and energy consumption is slight because only angle control of the movable wings 502, 504, 506, and 508 is performed. However, when it is difficult to hold the home position by this mechanism alone due to bad weather, etc., a propulsion mechanism such as a screw is separately driven from a propulsion drive source, and the autonomous navigation type marine buoy 1 is navigated to the home position.

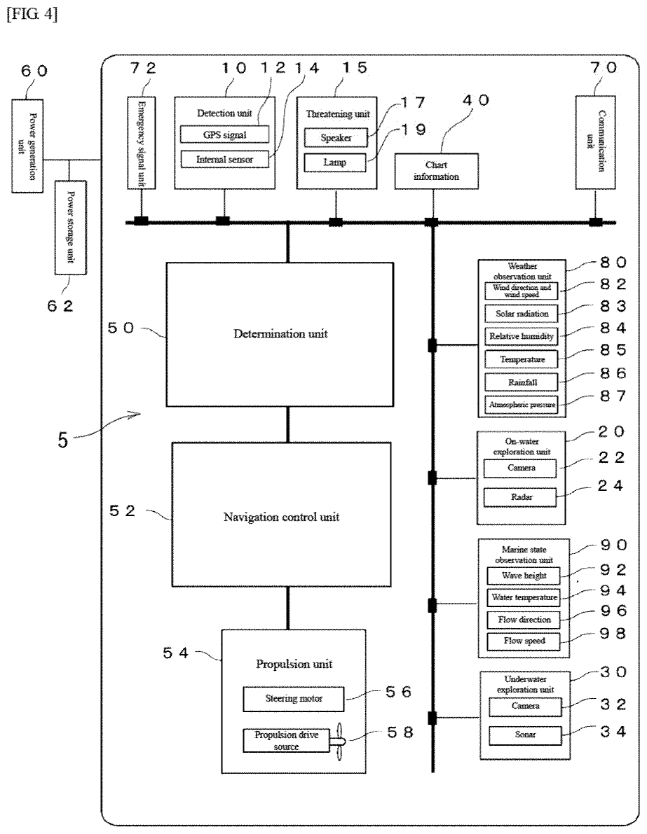

Next, a functional configuration of the autonomous navigation type marine buoy 1 will be described with reference to FIG. 4. FIG. 4 is a block diagram showing an overall configuration of a control system of the autonomous navigation type marine buoy 1.

As shown in FIG. 4, the autonomous navigation type marine buoy 1 includes an emergency signal unit 72, the detection unit 10, a threatening unit 15, a storage unit for chart information 40, the communication unit 70, a weather observation unit 80, the on-water exploration unit 20, the marine state observation unit 90, the underwater exploration unit 30, a determination unit 50, a navigation control unit 52, a propulsion unit 54, a power generation unit 60, and a power storage unit 62. The determination unit 50 and the navigation control unit 52 constitute a control device 5 that controls operation of the autonomous navigation type marine buoy 1. The control device 5 includes at least one computer, and each computer has a processor, volatile and nonvolatile memories, an I/O interface, and the like. In the control device 5, each function is realized by the processor performing arithmetic processing using the volatile memory based on a program stored in the nonvolatile memory.

The emergency signal unit 72 receives a distress signal from a victim. The detection unit 10 is equipped with a GPS signal receiver 12 and an internal sensor 14, and acquires its position information. The threatening unit 15 performs threatening operation on an intruder detected by the on-water exploration unit 20 or the underwater exploration unit 30 using a speaker 17 and a lamp 19. The chart information 40 includes ocean current data, electronic chart data, seafloor topographic data, and the like. The communication unit 70 communicates with the outside. The communication unit 70 may be equipped with an automatic identification system (AIS) and receive ship-specific data such as an identification code, a ship name, a position, a course, ship speed, and a destination from a distress ship. Further, it is desirable that the communication unit 70 have a function as a wireless relay base station.

The weather observation unit 80 measures a wind direction and wind speed 82, solar radiation 83, relative humidity 84, temperature 85, rainfall 86, and atmospheric pressure 87. The on-water exploration unit 20 explores a state on the sea. The on-water exploration unit 20 may be configured by an on-water camera 22 (video camera) capable of photographing 360 degrees, a radar 24, and the like. The marine state observation unit 90 measures a wave height 92, water temperature 94, a flow direction 96, and flow speed 98. The underwater exploration unit 30 monitors a state under the sea. The underwater exploration unit 30 may be configured by the underwater camera 32 (video camera) capable of photographing 360 degrees, the sonar 34, and the like. Further, the underwater exploration unit 30 may include a gravimeter (not shown) and a magnetometer (not shown) that can explore various marine mineral resources such as a seafloor hydrothermal deposit and a cobalt rich crust that exist under the seabed. The gravimeter measures gravity at a point where the buoy body 2 is located to examine geology under the seabed, and recognizes a difference and distribution of materials that exist under the seabed from changes in gravity. The magnetometer detects magnetic anomalies at that point, and recognizes a difference and distribution of materials.

The determination unit 50 creates a navigation plan for the buoy body 2 along a target route set based on the position information of the buoy body 2 detected by the detection unit 10 and the chart information 40. The navigation control unit 52 performs drive control of the propulsion unit 54 so that the buoy body 2 navigates according to the navigation plan generated by the determination unit 50. The propulsion unit 54 propels the buoy body 2 by the steering motor 56 and a propulsion drive source 58 in accordance with a command from the navigation control unit 52. The propulsion unit 54 may include a rudder for controlling a navigation direction of the buoy body 2, the steering motor 56 for operating a mechanism of the movable wings 502, 504, 506, and 508 and a screw for propelling the buoy body 2, and the propulsion drive source 58 for driving a water jet. The propulsion drive source 58 may be a motor or a fuel engine.

The power generation unit 60 generates power with natural energy. The power storage unit 62 stores surplus electric energy generated by the power generation unit 60 and supplements electric energy that is deficient in the power generation unit 60. These functional units are connected by information transmission paths, and necessary power is supplied from the power generation unit 60 and the power storage unit 62 to the functional units. Energy consumed by the autonomous navigation type marine buoy 1 is supplied from the power generation unit 60 that performs natural energy power generation and the power storage unit 62 that stores electricity generated by the power generation unit 60. Surplus electricity of the power generation unit 60 is stored in the power storage unit 62, and when the power generation unit 60 cannot generate power or when electricity of the power generation unit 60 is insufficient, electricity is supplied from the power storage unit 62. Solar power generation and wave power generation are adopted for a power generation method. Furthermore, a fuel generator may be preliminarily equipped to generate power urgently when natural energy power generation is not possible. At this time, the minimum necessary fuel such as gasoline and light oil is stored in the buoy body 2.

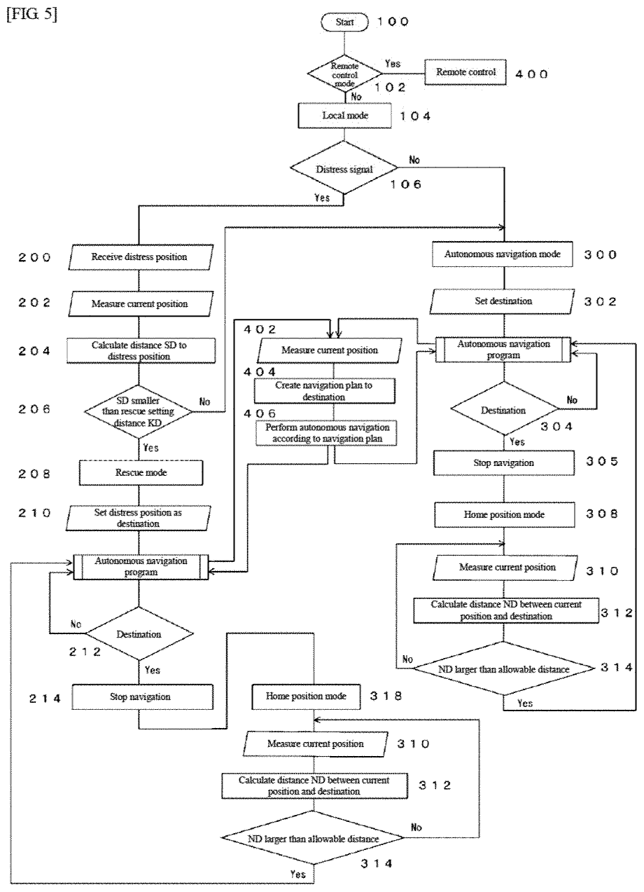

Next, a control flow of the autonomous navigation type marine buoy 1 will be described with reference to FIG. 5. FIG. 5 is a flowchart showing the control flow of the autonomous navigation type marine buoy 1.

The navigation control unit 52 of the autonomous navigation type marine buoy 1 has a plurality of control modes of a remote control mode and a local control mode. The communication unit 70 of the autonomous navigation type marine buoy 1 can receive an external command, and remote control is performed from a predetermined external location. In the remote control mode, all functions of the autonomous navigation type marine buoy 1 can be controlled from the predetermined external location. In the remote control mode, a navigation destination can be changed from the outside, and even when the autonomous navigation type marine buoy 1 is outside a rescue setting distance, it can be used for the rescue of a victim by switching to a rescue mode.

Each of the remote control mode and the local control mode includes an autonomous navigation mode, a home position mode, and a rescue mode.

The autonomous navigation type marine buoy 1 in the autonomous navigation mode grasps its own absolute position by receiving a GPS signal in the detection unit 10, and grasps its own traveling state with a gyro sensor, an electronic compass, a speedometer, etc. While the determination unit 50 performs comparison operation with the chart information 40 stored in advance in the storage device, the determination unit 50 and the navigation control unit 52 control the propulsion unit 54. Thus, the autonomous navigation type marine buoy 1 can autonomously perform automatic navigation to a destination.

The autonomous navigation type marine buoy 1 in the home position mode holds a home position by repeating position correction, while performing comparison operation similar to that of the autonomous navigation mode. At this time, the on-water exploration unit 20 mounted on the buoy body 2 monitors a state on the sea. Further, the underwater exploration unit 30 mounted on the buoy body 2 monitors a state under the sea. Information captured by the on-water exploration unit 20 and the underwater exploration unit 30 may be transmitted to the outside via the communication unit 70.

The autonomous navigation type marine buoy 1 in the rescue mode can autonomously navigate to a destination in the same manner as in the autonomous navigation mode, with the destination as a transmission position of a distress signal.

As shown in FIG. 5, when the control device 5 starts control in step 100, first, in step 102, it determines whether or not a control mode is a remote control mode. If the control mode is the remote control mode, the autonomous navigation type marine buoy 1 is remotely controlled from a predetermined external location. If the control mode is not the remote control mode, the control device 5 starts control of the autonomous navigation type marine buoy 1 in a local control mode in step 104.

When the local control mode is started, it is determined in step 106 whether or not there is a distress signal. If there is no distress signal, the process is shifted to an autonomous navigation mode in step 300. In the autonomous navigation mode, setting processing of a destination is performed in step 302, and a subroutine autonomous navigation program is executed from step 402.

The control device 5 (the determination unit 50) acquires its own current position using the information detected by the detection unit 10 in step 402, and calculates a direction and a distance from the current position to the destination as needed to create a navigation plan in step 404. Then, in step 406, the control device 5 (the navigation control unit 52) navigates the buoy body 2 to the destination according to the navigation plan. Next, the control device 5 determines whether or not the buoy body 2 has reached the destination in step 304, and if not yet reached, processing from step 402 to step 304 is repeated until the buoy body 2 reaches the destination.

If it is determined in step 304 that the buoy body 2 has reached the destination, the control device 5 stops the navigation of the autonomous navigation type marine buoy 1, and the process is shifted to a home position mode in step 308. When the process is shifted to the home position mode in step 308, the control device 5 next measures its own current position using the information detected by the detection unit 10 in step 310.

The control device 5 calculates a distance between the current position and the destination in step 312. If the distance is larger than a preset allowable distance in step 314, the control device 5 executes the autonomous navigation program again, and the autonomous navigation type marine buoy 1 navigates to the destination. If the distance between the current position and the destination is smaller than the allowable distance in step 314, the processing is returned to step 310, and the control device 5 repeats home position mode processing. The above is description of the control flow in the autonomous navigation mode and the home position mode.

Next, control when there is a distress signal in step 106 will be described. When receiving a distress position in step 200, the control device 5 measures its own current position in step 202. Subsequently, the control device 5 calculates a distance from the current position to the distress position in step 204. Then, if the distance from the current position to the distress position is smaller than a preset rescue setting distance 700 in step 206, the process is shifted to a rescue mode in step 208.

If the rescue mode is set in step 208, the control device 5 resets the distress position as the destination in step 210, and executes the subroutine autonomous navigation program. The processing from step 402 to step 406 thereafter is as described above.

If it is determined in step 212 that the autonomous navigation type marine buoy 1 has reached the destination, the control device 5 stops the navigation of the autonomous navigation type marine buoy 1, and the process is shifted to a home position mode in step 318. Thereafter, the same control as in the autonomous navigation mode is repeated, and the autonomous navigation type marine buoy 1 holds a home position.

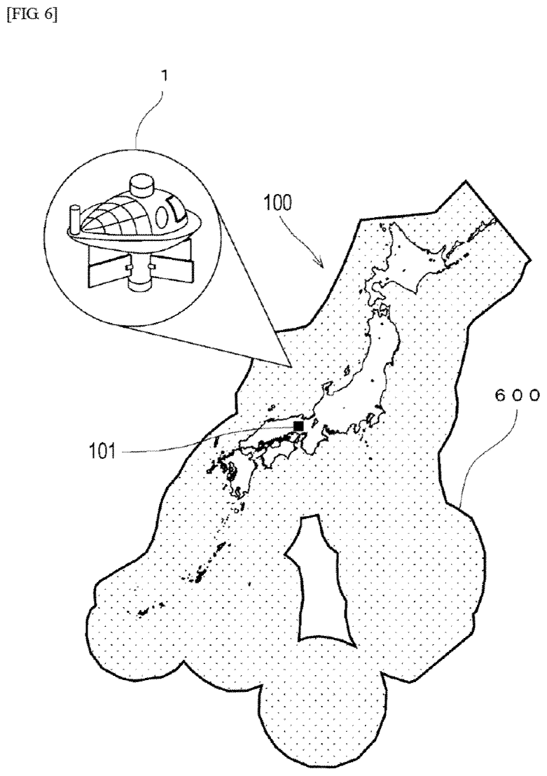

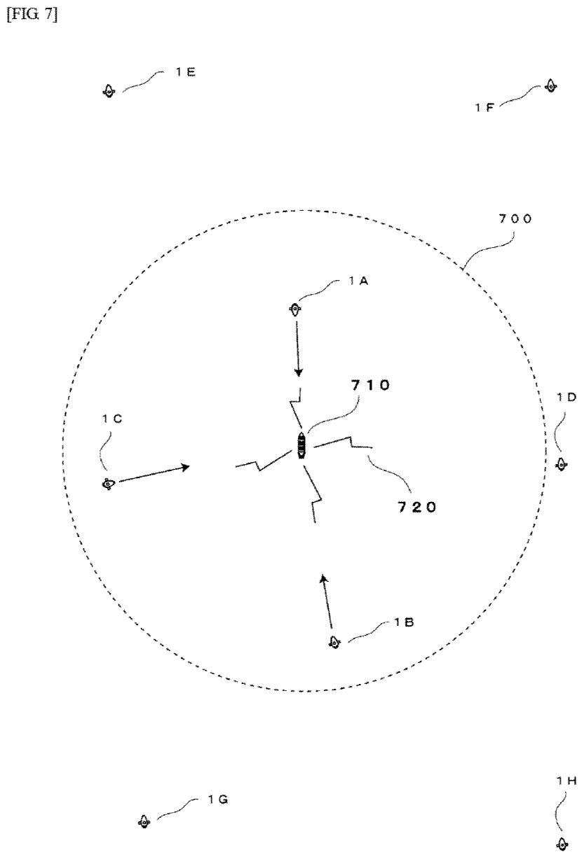

Finally, a marine information system 100 according to an embodiment of the present invention will be described with reference to FIGS. 6 and 7. FIG. 6 is a view showing a state in which a plurality of autonomous navigation type marine buoys 1 are arranged in a lattice form in Japan's exclusive economic zone, and FIG. 7 is a view for describing rescue operation of the autonomous navigation type marine buoys as the marine information system 100.

The marine information system 100 according to the present embodiment includes about 2000 autonomous navigation type marine buoys 1 arranged at intervals of about 50 km in an area of an exclusive economic zone 600 set around Japan. According to this marine information system 100, it is possible to monitor states on the sea and under the sea, grasp weather and marine state information, construct a maritime rescue network, and construct a wireless communication network for all areas in Japan's exclusive economic zone. Each autonomous navigation type marine buoy 1 has the communication unit 70 as described above, and can send and receive information to and from a server 101 provided at a predetermined position. The information captured by each autonomous navigation type marine buoy 1 (for example, weather and marine state information) is transmitted to the server 101 in real time. In other words, the information captured by each autonomous navigation type marine buoy 1 can be grasped in real time at a predetermined location.

Next, the rescue operation of the marine information system 100 will be described with reference to FIG. 7. FIG. 7 is an enlarged view of a part of FIG. 6. Eight autonomous navigation type marine buoys 1A to 1H are located around a distress ship 710. The autonomous navigation type marine buoy 1A, the autonomous navigation type marine buoy 1B, and the autonomous navigation type marine buoy 1C are located within the rescue setting distance 700. The autonomous navigation type marine buoy 1D, the autonomous navigation type marine buoy 1E, the autonomous navigation type marine buoy 1F, the autonomous navigation type marine buoy 1G, and the autonomous navigation type marine buoy 1H are located outside the rescue setting distance 700. The rescue setting distance 700 is set as appropriate.

The distress ship 710 transmits a distress signal 720, which is received by all the autonomous navigation type marine buoys 1A to 1H. In each of the autonomous navigation type marine buoys 1A to 1H, the control device 5 calculates a distance between its own position and a position of the distress ship 710. If the distance is smaller than the preset rescue setting distance 700, the control device 5 controls the autonomous navigation type marine buoy 1 to autonomously go to the distress position to rescue. In other words, the autonomous navigation type marine buoy 1A, the autonomous navigation type marine buoy 1B, and the autonomous navigation type marine buoy 1C that are located within the rescue setting distance 700 from the distress ship 710 autonomously go to the rescue of the distress ship 710. Note that the position of the distress ship 710 is a transmission position of a distress signal.

When a scale of a distress accident is large, the number of autonomous navigation type marine buoys 1 that go to rescue needs to be increased. In such a case, a control mode of the necessary number of autonomous navigation type marine buoys 1 is forcibly switched to a remote control mode and a rescue mode by remote control from a central control device (not shown) provided at a predetermined location. The autonomous navigation type marine buoy 1 switched to the rescue mode starts navigation toward the position of the distress ship 710. In the autonomous navigation type marine buoy 1, the remote control mode is given priority over the local control mode.

Similarly, in the event of a major disaster on land, by gathering the autonomous navigation type marine buoys 1 navigating in the vicinity on a coast, these autonomous navigation type marine buoys 1 can also be used as evacuation sites for victims.

In addition, the autonomous navigation type marine buoy 1 can also search for a distress ship, a victim, and a drifting object using the functions of the on-water exploration unit 20 and the underwater exploration unit 30.

As described above, the autonomous navigation type marine buoy 1 of the present embodiment includes a buoy body 2 consisting of a floating body, at least one internal sensor 14 provided in the buoy body 2, a detection unit 10 that receives a GPS signal and information of the internal sensor 14, an on-water exploration unit 20 that explores a state on a sea, an underwater exploration unit 30 that explores a state under the sea, a determination unit 50 that creates a navigation plan for the buoy body 2 along a target route set based on position information of the buoy body 2 detected by the detection unit 10 and chart information 40, a propulsion unit 54 that propels the buoy body 2, a navigation control unit 52 that performs drive control of the propulsion unit 54 so that the buoy body 2 navigates according to the navigation plan generated by the determination unit 50, a power generation unit 60 that generates power using natural energy, a power storage unit 62 that stores electricity generated by the power generation unit 60 and supplies electricity to a necessary location in the buoy body 2, a communication unit 70 that communicates with an outside, an emergency signal unit 72 that receives a distress signal and specifies a transmission position of the distress signal, and an evacuation room 4A that accommodates a victim. Also, the autonomous navigation type marine buoy 1 has an autonomous navigation mode of performing autonomous navigation to a set position on the sea, a home position mode of autonomously holding a home position at the set position on the sea, and a rescue mode of performing autonomous navigation to the transmission position of the distress signal on the sea when the distress signal is received.

In addition to the functions of autonomous navigation to a destination and holding of the home position on the sea based on the GPS signal, the information of the internal sensor 14, and the chart information 40, the autonomous navigation type marine buoy 1 configured as described above has a function of autonomously rescuing a victim in a marine accident. Generally, when a ship is in distress, a distress signal is transmitted automatically or manually. This signal is transmitted in a predetermined format, and includes a call sign of a distress ship, distress position information obtained from a GPS receiver, clock information, and the like. The autonomous navigation type marine buoy 1 enters the rescue mode when receiving these pieces of information, automatically creates a navigation route from its own position to a distress position, and autonomously goes to the distress position to rescue a victim without waiting for an external command. It is more effective to place multiple autonomous navigation type marine buoys 1 at marine accident frequent occurrence spots.

Also, the autonomous navigation type marine buoy 1 configured as described above includes the evacuation room 4A in which a victim can stay temporarily. An entrance 4 to the evacuation room 4A may be provided at an upper part of the buoy body 2. After the victim is transferred to the buoy body 2, he/she opens the entrance 4 of the evacuation room 4A and enters the evacuation room 4A. It is desirable that the evacuation room 4A be provided with the minimum supplies necessary for a person to live for several days, such as food and drink, bedding, and a simple toilet. Further, the buoy body 2 may be provided with a transparent window 6 through which the outside can be viewed from the evacuation room 4A.

In addition, when the emergency signal unit 72 receives the distress signal, the autonomous navigation type marine buoy 1 according to the present embodiment autonomously goes to the transmission position of the distress signal to rescue on condition that the autonomous navigation type marine buoy 1 is within a predetermined distance from the transmission position of the distress signal.

When the autonomous navigation type marine buoy 1 configured as described above receives position information of a distress ship 710 by the communication unit 70, it calculates a distance from its own position to a distress position. When the distance is smaller than a preset rescue setting distance 700, the autonomous navigation type marine buoy 1 enters a rescue mode and autonomously goes to the distress position to rescue a victim without waiting for an external command. As a result, when a plurality of autonomous navigation type marine buoys 1 are arranged, it is possible to avoid a phenomenon that all the autonomous navigation type marine buoys 1 that have received the distress signal go to rescue.

In addition, the autonomous navigation type marine buoy 1 according to the present embodiment further includes a plurality of rotatable thin plate-like movable wings 502, 504, 506, and 508 provided outside the buoy body 2 located in the sea, in which an extending direction of a rotating shaft of at least one movable wing is identical to a traveling direction of the buoy body 2, and the navigation control unit 52 controls rotation angles of the plurality of movable wings 502, 504, 506, and 508, so that the buoy body 2 is held at a home position when the buoy body 2 is moved up and down by waves.

In the autonomous navigation type marine buoy 1 configured as described above, an absolute position of the buoy body 2 is moved up and down by waves. The movable wings 502, 504, 506, and 508 located in the sea also rise in the sea when a sea surface rises and descend in the sea when the sea surface descends. At this time, by controlling the angles of the movable wings 502, 504, 506, and 508, a position of the buoy body 2 can be changed. By repeating the angle control of the movable wings 502, 504, 506, and 508, the buoy body 2 can hold the home position. Further, by holding the movable wing having the rotating shaft extending in the direction identical to the traveling direction of the buoy body 2 in a vertical direction, it is possible to ensure straightness when the buoy body 2 navigates to a destination.

In addition, the autonomous navigation type marine buoy 1 according to the present embodiment includes a thin plate-like first movable wing 504 provided rotatably on a right side of the buoy body 2 around a first rotating shaft 504a orthogonal to a traveling direction of the buoy body 2, a thin plate-like second movable wing 502 provided rotatably on a left side of the buoy body 2 around a second rotating shaft 502a orthogonal to the traveling direction of the buoy body 2, and a thin plate-like third movable wing 506 provided rotatably on a front side of the buoy body 2 around a third rotating shaft 506a parallel to the traveling direction of the buoy body 2, and a thin plate-like fourth movable wing 508 provided rotatably on a front side of the buoy body 2 around a fourth rotating shaft 508a parallel to the traveling direction of the buoy body 2. Here, the front in the traveling direction as viewed from the buoy body 2, the rear on the side opposite to the front, and the left and right as viewed from the buoy body 2 are defined.

The autonomous navigation type marine buoy 1 configured as described above can control the traveling direction when navigating to the destination by the first movable wing 504 and the second movable wing 502 provided on the right and left of the buoy body 2. In addition, the third movable wing 506 and the fourth movable wing 508 provided front and rear of the buoy body 2 are kept vertical, and angles of the first movable wing 504 and the second movable wing 502 are controlled. With this configuration, the buoy body 2 can turn left and right. When the buoy body 2 turns right, the first movable wing 504 is held in a vertical direction, and the second movable wing 502 is held in a horizontal direction.

Moreover, the autonomous navigation type marine buoy 1 according to the present embodiment further includes a weather observation unit 80 that observes weather and a marine state observation unit 90 that observes a marine state.

By providing the weather observation unit 80 and the marine state observation unit 90 in this way, natural phenomena on the sea and in the sea can be constantly observed. The weather observation unit 80 may include an observation device for a wind direction and wind speed, solar radiation, relative humidity, temperature, rainfall, and atmospheric pressure, and the marine state observation unit 90 may include an observation device for a wave height, water temperature, a flow direction, and flow speed. The observation information is stored in a storage device installed in the buoy body 2 and is also transmitted to a predetermined location via the communication unit 70. The observation information may be used in weather forecast, economic operation of a ship, other industries such as fishing, marine leisure, and a field of lifesaving.

In addition, in the autonomous navigation type marine buoy 1 according to the present embodiment, when the on-water exploration unit 20 or the underwater exploration unit 30 detects a moving object that has entered a certain area, the communication unit 70 reports to a predetermined external location.

As a result, when the on-water exploration unit 20 finds a moving object such as a suspicious ship that has entered a surveillance area, or when the underwater exploration unit 30 finds a moving object such as a suspicious submarine that has entered the surveillance area, a report is made to the predetermined external location via the communication unit 70. An intruder found can be identified with an AIS. Further, in the on-water exploration unit 20 and the underwater exploration unit 30, automatic detection of a moving object by a camera image can be realized by a publicly known technique that performs image processing by setting a wanting line on an image.

The above-mentioned autonomous navigation type marine buoy 1 further includes a threatening unit 15, in which when the on-water exploration unit 20 or the underwater exploration unit 30 detects a moving object that has entered a certain area, the communication unit 70 may automatically report to a predetermined external location, and the threatening unit 15 may perform threatening operation. The threat may be performed by voice warning by a speaker 17, irradiation by a lamp 19, or the like. The threat may be performed only when the detected moving object is determined to be a suspicious ship by the AIS.

Further, in the autonomous navigation type marine buoy 1 according to the present embodiment, the communication unit 70 has a function as a wireless relay base station.

For example, mobile phone calls on the sea are conducted by radio waves from coastal base stations and some shipboard base stations. However, areas covered by these base stations are limited, and mobile phones cannot substantially be used on the sea far from the coast. In addition, a call using a communication satellite is possible on the sea, but it is not as convenient as a mobile phone on the ground. Also, when a ground base station becomes unavailable in an emergency, an experiment has been conducted to secure a communicable area by placing a mobile phone relay base station on a balloon or drone.

As described above, by allowing the autonomous navigation type marine buoy 1 to have the functions as the wireless relay base station and providing it at a required location on the sea, a comfortable wireless communication environment can be constructed on the sea as well as on the ground. In addition, for example, when land radio base stations become unusable in the event of occurrence of a major disaster such as a large earthquake, by gathering the autonomous navigation type marine buoys 1 navigating in the vicinity on the coast, these autonomous navigation type marine buoys 1 can complement a function as a radio base station for land communication.

In addition, the autonomous navigation type marine buoy 1 according to the present embodiment has a local control mode and a remote control mode of receiving remote control from an outside, and the remote control mode has priority over the local control mode.

As a result, for example, when a large-scale distress accident occurs, in the local control mode, the autonomous navigation type marine buoy 1 located at a position farther than the rescue setting distance 700 from the distress ship 710 does not enter the rescue mode. However, in the remote control mode, the autonomous navigation type marine buoy 1 can be forcibly set to the rescue mode to rescue.

Further, a marine information system 100 according to the present embodiment includes a plurality of the autonomous navigation type marine buoys 1 arranged in a lattice form in a certain water area.

According to the marine information system 100 configured as described above, in an area where the autonomous navigation type marine buoys 1 are arranged, it is possible to monitor states on the sea and under the sea, grasp weather and marine state information, construct a maritime rescue network, and construct a wireless communication network. For example, when the autonomous navigation type marine buoys 1 are arranged at equal intervals of 50 km in Japan's exclusive economic zone, about 2000 units are arranged. In this way, it will be possible to monitor states on the sea and under the sea, grasp weather and marine state information, construct a maritime rescue network, and construct a wireless communication network for all areas in Japan's exclusive economic zone.

### REFERENCE SIGNS LIST

1 autonomous navigation type marine buoy
1A to 1H autonomous navigation type marine buoys arranged in a lattice form
2 buoy body
4 evacuation room entrance
4A evacuation room
5 control device
6 transparent window
10 detection unit
12 GPS signal receiver
14 internal sensor
15 threatening unit
17 speaker
19 lamp
20 on-water exploration unit
22 on-water camera
24 radar
30 underwater exploration unit
32 underwater camera
34 sonar
40 chart information
42 surveillance camera
50 determination unit
52 navigation control unit
54 propulsion unit
56 steering motor
58 propulsion drive source
60 power generation unit
62 power storage unit
64 solar power generation panel
70 communication unit
72 emergency signal unit
80 weather observation unit
82 wind direction and wind speed
83 solar radiation
84 relative temperature
85 temperature
86 rainfall
57 atmospheric pressure
90 marine state observation unit
92 wave height
94 water temperature
96 flow direction
98 flow speed
100 marine information system
101 server
502 left movable wing (second movable wing)
504 right movable wing (first movable wing)
506 front movable wing (third movable wing)
508 rear movable wing (fourth movable wing)
510 movable wing support unit
600 exclusive economic zone
700 rescue setting distance
710 distress ship
720 distress signal
900 sea surface when there is a wave
902 sea surface when there is no wave

What is claimed is:

1. An autonomous navigation type marine buoy comprising:
a buoy body consisting of a floating body;
at least one internal sensor provided in the buoy body;
a detection unit that receives a GPS signal and information of the internal sensor;
an on-water exploration unit that explores a state on a sea;
an underwater exploration unit that explores a state under the sea;
a determination unit that creates a navigation plan for the buoy body along a target route set based on position information of the buoy body detected by the detection unit and chart information;
a propulsion unit that propels the buoy body;
a navigation control unit that performs drive control of the propulsion unit so that the buoy body navigates according to the navigation plan generated by the determination unit;
a power generation unit that generates power using natural energy;
a power storage unit that stores electricity generated by the power generation unit and supplies electricity to a necessary location in the buoy body;
a communication unit that communicates with an outside;
an emergency signal unit that receives a distress signal and specifies a transmission position of the distress signal; and
an evacuation room that accommodates a victim,
wherein the autonomous navigation type marine buoy has
an autonomous navigation mode of performing autonomous navigation to a set position on the sea,
a home position mode of autonomously holding a home position at the set position on the sea, and
a rescue mode of performing autonomous navigation to the transmission position of the distress signal on the sea when the distress signal is received.

2. The autonomous navigation type marine buoy according to claim 1, wherein
when the emergency signal unit receives the distress signal, the autonomous navigation type marine buoy autonomously goes to the transmission position of the distress signal to rescue on condition that the autonomous navigation type marine buoy is within a predetermined distance from the transmission position of the distress signal.

3. The autonomous navigation type marine buoy according to claim 1, further comprising
a plurality of rotatable thin plate-like movable wings provided outside the buoy body located in the sea,
wherein an extending direction of a rotating shaft of at least one movable wing is identical to a traveling direction of the buoy body, and
the navigation control unit controls rotation angles of the plurality of movable wings, so that the buoy body is held at a home position when the buoy body is moved up and down by waves.

4. The autonomous navigation type marine buoy according to claim 1, further comprising:
a thin plate-like first movable wing provided rotatably on a right side of the buoy body around a first rotating shaft orthogonal to a traveling direction of the buoy body;
a thin plate-like second movable wing provided rotatably on a left side of the buoy body around a second rotating shaft orthogonal to the traveling direction of the buoy body;
a thin plate-like third movable wing provided rotatably on a front side of the buoy body around a third rotating shaft parallel to the traveling direction of the buoy body; and
a thin plate-like fourth movable wing provided rotatably on a rear side of the buoy body around a fourth rotating shaft parallel to the traveling direction of the buoy body.

5. The autonomous navigation type marine buoy according to claim 1, to further comprising:
a weather observation unit that observes weather; and a marine state observation unit that observes a marine state.

6. The autonomous navigation type marine buoy according to claim 1, wherein
when the on-water exploration unit or the underwater exploration unit detects a moving object that has entered a certain area, the communication unit reports to a predetermined external location.

7. The autonomous navigation type marine buoy according to claim 1, further comprising
a threatening unit,
wherein when the on-water exploration unit or the underwater exploration unit detects a moving object that has entered a certain area, the communication unit automatically reports to a predetermined external location, and the threatening unit performs threatening operation.

8. The autonomous navigation type marine buoy according to claim 1, wherein
the communication unit has a function as a wireless relay base station.

9. The autonomous navigation type marine buoy according to claim 1, wherein
the autonomous navigation type marine buoy has a local control mode and a remote control mode of receiving remote control from an outside, and the remote control mode has priority over the local control mode.

10. A marine information system comprising a plurality of the autonomous navigation type marine buoys according to claim 1 arranged in a lattice form in a certain water area.
